(19) United States
(12) Patent Application Publication
(10) Pub. No.: US 2017/0113666 A1
(43) Pub. Date: Apr. 27, 2017

(54) METHOD AND DEVICE FOR BRAKING A VEHICLE, AND VEHICLE

(71) Applicant: Leauto Intelligent Technology (BEIJING) Co. Ltd., Beijing (CN)

(72) Inventors: Yong XU, Beijing (CN); WenRui LI, Beijing (CN); Wei LIN, Beijing (CN); Yu ZOU, Beijing (CN); XiaoFei GOU, Beijing (CN); Peng LIU, Beijing (CN); Dan LI, Beijing (CN)

(21) Appl. No.: 14/978,849

(22) Filed: Dec. 22, 2015

(30) Foreign Application Priority Data
Oct. 23, 2015 (CN) 201510698182.9

(51) Int. Cl. B60T 7/22; B60R 16/023; B60Q 9/00; G01S 13/93

(52) U.S. Cl. CPC B60T 7/22; G01S 13/931; B60R 16/023; B60Q 9/008

(57) ABSTRACT

The embodiments of the present disclosure provide a method and a device for braking a vehicle and a vehicle. After the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to making braking, the misjudgment possibility for making braking may be reduced, and thus the technical problem of being dangerous when implementing emergency braking using V2X in the related art is solved.

### CROSS-REFERENCE TO RELATED APPLICATIONS

This application is based on and claims priority to Chinese Patent Application No. 201510698182.9, filed on Oct. 23, 2015, the full disclosure of which is hereby incorporated by reference in its entirety.

### TECHNICAL FIELD

The present disclosure relates to vehicle engineer, and more particularly to a method and a device for braking a vehicle, and a vehicle.

### BACKGROUND

V2X (Vehicle to X) is a key technology in the future intellectual traffic and transportation system, which enables communications between vehicles and vehicles, between vehicles and base stations, base stations and base stations, and thus it is possible to obtain a series of traffic information such as real-time traffic, information on road, information on people on the road and so on, thereby improving driving safety, reducing traffic congestion, improving traffic efficiency, providing information of on-vehicle entertainment, and so on.

In the technical standard of V2X, emergency braking is one of the typical application scenarios. However, in the procedure of implementing foregoing vehicle braking, the applicants of the present disclosure have found problems in the prior art as follows: Although V2X is strong in the aspect of real-time, it has inadequate security of data, lacks authentication in communication and verification on identification, makes misjudgment due to interference by receiving other signals, and meanwhile, when there is instructions for emergency braking sent by malicious base station, it is impossible for protocol based on V2X standard to make identification, which facilitate criminals to make harm to the society. Therefore, it is very dangerous to implement emergency braking using V2X technology in the related art.

### SUMMARY

The embodiments of the present disclosure provide a method and a device for braking a vehicle, and a vehicle, which may solve the technical problem of being dangerous when implementing emergency braking using V2X in the related art.

To achieve the foregoing objects, the embodiments of the present disclosure disclose technical solutions as follows:

According to a first aspect, there is provided a device for braking a vehicle including: a communication module, a processor, a ranging radar, and a braking device. The communication module, the ranging radar, and the braking device are electrically connected with the processor, respectively. The communication module is configured to receive a braking instruction from an nearby vehicle based on V2X communication. The ranging radar is configured to detect the presence or non-presence of obstacle within preset safe range, and when the presence of obstacle within preset safe range is detected, transmit an indicating signal to the processor. The processor is configured to transmit an activation signal to the braking device to actuate the braking device to perform braking when the braking instruction is received via the communication module and the indicating signal transmitted from the ranging radar is received. The braking device is configured to perform braking when the activation signal is received.

According to an embodiment of the present disclosure, in the device for braking a vehicle as described above, the ranging radar includes at least one of millimeter-wave ranging radar and laser ranging radar.

According to an embodiment of the present disclosure, in the device for braking a vehicle as described above, if the ranging radar includes millimeter-wave ranging radar or laser ranging radar, the ranging module is further configured to include a judging circuit configured to be electrically connected with the millimeter-wave ranging radar and the laser ranging radar, respectively.

The judging circuit is configured to judge whether or not both the millimeter-wave ranging radar and the laser ranging radar determine that there is obstacle within the preset safe range, and when both the millimeter-wave ranging radar and the laser ranging radar determine that there is an obstacle within the preset safe range, transmit the indicating signal to the processor.

According to an embodiment of the present disclosure, in the device for braking a vehicle as described above, the processor is further configured to indicate the presence or non-presence of the obstacle within the preset safe range detected by the ranging radar, when the braking instruction via the communication module is received, and to transmit an activation signal to the braking device to actuate the braking device to perform braking when the indicating signal transmitted from the ranging radar is received.

According to an embodiment of the present disclosure, in the device for braking a vehicle as described above, the ranging radar is further configured to detect the presence or non-presence of the obstacle within the preset safe range in real-time, and to transmit an indicating signal to the processor when the presence of the obstacle within the preset safe range is detected.

The processor is further configured to transmit an activation signal to the braking device to actuate the braking device to perform braking, if the braking instruction is received via the communication module in the preset time period before or after the indicating signal transmitted from the ranging radar is received.

Alternatively, the processor is further configured to transmit an activation signal to the braking device to actuate the braking device to perform braking, if the indicating signal transmitted from the ranging radar is received in the preset time period before or after the braking instruction is received via the communication module.

According to an embodiment of the present disclosure, in the device for braking a vehicle as described above, the processor is configured to be connected with the braking device via a CAN (Controller Area Network) bus controller and a CAN bus.

According to an embodiment of the present disclosure, the device for braking a vehicle as described above further includes an alarm configured to be electrically connected with the processor.

The processor is further configured to actuate the alarm to make alarm with sound and light when the indicating signal is received.

According to the second aspect, there is provided a vehicle including the device for braking a vehicle as described above.

According to the third aspect, there is provided a method for braking a vehicle including: receiving a braking instruction from nearby vehicles based on V2X communication; detecting the presence or non-presence of obstacles within a preset safe range by a ranging radar; actuating a braking device to perform braking when the presence of the obstacle within the preset safe range is detected.

According to the fourth aspect, there is provided a device for braking a vehicle, comprising: one or more processors; a memory; and one or more programs stored in the memory and configured to perform operations when executed by the one or more processors, wherein the operations comprises: receiving a braking instruction from nearby vehicles based on V2X communication; detecting the presence or non-presence of obstacles within a preset safe range by a ranging radar; and actuating a braking device to perform braking when the presence of the obstacle within the preset safe range is detected.

In the embodiments of the present disclosure, after the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to performing braking, the misjudgment possibility for performing braking may be reduced, and thus the technical problem of being dangerous when implementing emergency braking using V2X in the related art is solved.

### BRIEF DESCRIPTION OF THE DRAWINGS

FIG. 1 is a structural schematic diagram of a device for braking a vehicle provided by a first embodiment of the present disclosure;

FIG. 2 is a structural schematic diagram of another device for braking a vehicle provided by a second embodiment of the present disclosure;

FIG. 3 is a flowchart of a method for braking a vehicle according to an embodiment of the present disclosure;

FIG. 4 is a flowchart of a method for braking a vehicle; and

FIG. 5 is a structural schematic diagram of another device for braking a vehicle provided by the present disclosure.

### DESCRIPTION OF THE EMBODIMENTS

In the following, description in detail would be made on the method and the device for braking a vehicle and the vehicle provided by the embodiments of the present disclosure in connection with the appended drawings.

### First Embodiment

FIG. 1 is a structural schematic diagram of a device for braking a vehicle provided by a first embodiment of the present disclosure. As shown in FIG. 1, a device for braking a vehicle includes a communication module 11, a processor 12, a ranging radar 13, and a braking device 14, wherein, the communication module 11, the braking device 14, and the ranging radar 13 are electrically connected with the processor 12, respectively.

The communication module 11 is configured to receive a braking instruction from nearby vehicles based on V2X communication.

More particularly, during the traveling of a vehicle, if the front vehicle is performing braking, the front vehicle may transmit a braking instruction to the present vehicle based on V2X communication to instruct the present vehicle to perform corresponding braking measures, and thus rear-end collision may be prevented. The device for braking a vehicle may perform communication with nearby vehicles via communication module 11 to receive the braking instructions.

The ranging radar 13 is configured to detect the presence or non-presence of obstacles within a preset safe range, and to transmit an indicating signal to the processor 12 when the presence of an obstacle within the preset safe range is detected.

More particularly, the ranging radar may have at least one probe, which may be mounted on the body of the vehicle so as to detect the presence or non-presence of obstacles within preset safe range.

The processor 12 is configured to transmit an activation signal to the braking device 14 to actuate the braking device 14 to perform braking when the braking instruction is received via the communication module 11 and the indicating signal transmitted from the ranging radar 13 is received.

More particularly, as a possible implementation, the processor 12 may actuate the ranging radar 13 to start when the braking instruction is received from the communication module 11, and if the indicating signal transmitted from the radar 13 is further received, the processor 12 may actuate the braking device 14 to perform braking. That is to say, the processor 12 is particularly configured to indicate the presence or non-presence of the obstacle within the preset safe range detected by the ranging radar 13 when the braking instruction is received via the communication module 11, and to transmit an activation signal to the braking device 14 to actuate the braking device 14 to perform braking when the indicating signal transmitted from the ranging radar 13 is received.

Alternatively, as another possible implementation, the ranging radar 13 may work under a mode of detecting obstacles in real-time, and transmit an indicating signal to the processor 12 when an obstacle is detected. If the processor 12 further receives a braking instruction in a preset time period before or after the indicating signal is received, the processor 12 may actuate the braking device 14 to perform braking; alternatively, if the processor receives the indicating signal transmitted from the ranging radar in the preset time period before or after the braking instruction is received, the processor transmits an activation signal to the braking device 14 to actuate the braking device to perform braking. That is to say, the ranging radar 13 is further configured to detect the presence or non-presence of the obstacle within the preset safe range in real-time, and to transmit an indicating signal to the processor when the presence of the obstacle within the preset safe range is detected. Accordingly, processor 12 is further configured to transmit an activation signal to the braking device 14 to actuate the braking device to perform braking, if the braking instruction is received via the communication module 11 in the preset time period before or after the indicating signal transmitted from the ranging radar 13 is received; alternatively, the processor 12 is further configured to transmit an activation signal to the braking device 14 to actuate the braking device 14 to perform braking, if the indicating signal transmitted from the ranging radar 13 is received in the preset time period before or after the braking instruction via the communication module 11 is received.

The braking device 14 is configured to perform braking when the actuation signal is received.

More particularly, the processor 12 is connected with the braking device 14 via a CAN bus controller and a CAN bus. The processor 12 transmits an activation signal for actuating the braking device 14 to perform braking to the braking device 14, and the CAN bus controller transmits the activation signal to the braking device 14.

In the present embodiment, after the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to performing braking, the misjudgment possibility for performing braking may be reduced, and thus the technical problem of being dangerous when implementing emergency braking using V2X in the related art is solved.

### Second Embodiment

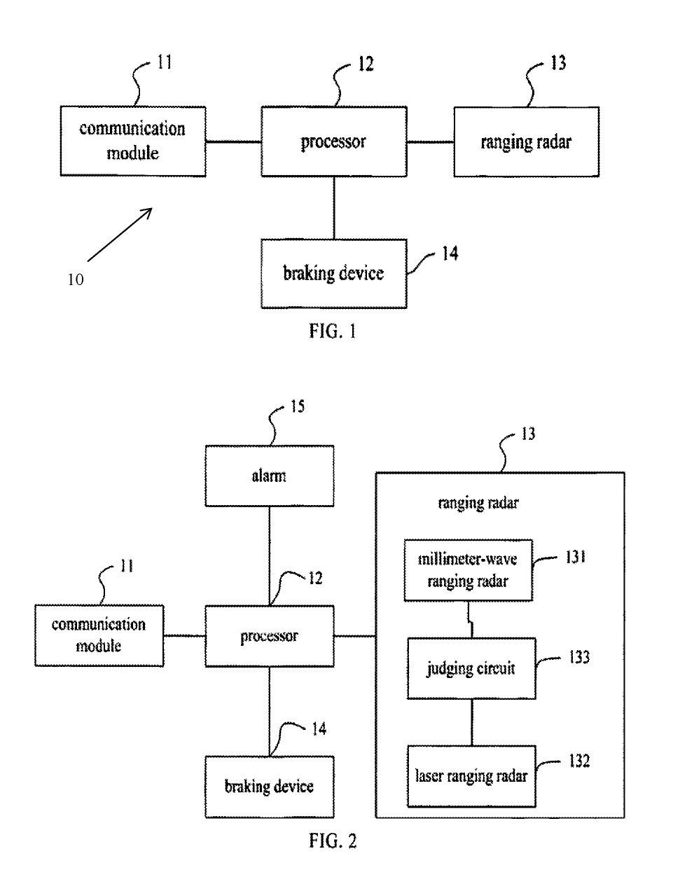

FIG. 2 is a structural schematic diagram of another device for braking a vehicle provided by a second embodiment of the present disclosure. Based on the foregoing embodiment, the ranging radar 13 in the present embodiment includes a millimeter-wave ranging radar 131, a laser ranging radar 132, and a judging circuit 133. The judging circuit 133 is electrically connected with the millimeter-wave ranging radar 131 and laser ranging radar 132.

More particularly, the millimeter-wave ranging radar 131 transmits a micro-wave signal of 77 GHz, and calculates the distance to the obstacle in front of the vehicle based on the arriving time of the reflected-wave. In normal case, the penetration capability of micro-wave is strongest and is able to adapt ranging work under different whether circumstances, but the micro-wave ranging is vulnerable to the reflecting-interference caused by the vehicles in adjacent lanes, which leads to the mistakes in determining distances.

Laser ranging radar 132 is configured to determine distances based on the reflecting time of the transmitted laser. Laser is widely used in automatic driving technology due to high accuracy, but is invulnerable to interference. However, the accuracy of laser would be attenuated in frog, which degrades its measuring accuracy.

The judging circuit 133 is configured to judge whether or not both the millimeter-wave ranging radar 131 and the laser ranging radar 132 determine that there is an obstacle within the preset safe range, and to transmit the indicating signal to the processor when both the millimeter-wave ranging radar 131 and the laser ranging radar 132 determine that there is an obstacle within the preset safe range.

More particularly, as a possible implementation, the processor 12 may be in standby state in normal circumstance, and transmit no data to the CAN bus, and transmit no emergency braking activation instructions to the CAN bus. When the communication module 11 receives the braking instructions transmitted from the front vehicle, the processor 12 may actuate both the millimeter-wave ranging radar 131 and the laser ranging radar 132 to start. By detecting the presence or non-presence of obstacles within preset safe range by the millimeter-wave ranging radar 131 and the laser ranging radar 132, the processor 12 may determine the state of the road ahead. Only when both the millimeter-wave ranging radar 131 and the laser ranging radar 132 detects the presence of vehicle ahead and the distance to the present vehicle is too short, the judging circuit 133 transmits an indicating signal. When the processor 12 receives the indicating signal indicating the presence of obstacles within the preset safe range, the processor 12 may transmit an activation signal for actuating the braking device 14 to perform braking via the CAN bus controller. The braking device 14 may perform emergency braking to ensure the driving safety after the activation signal is received.

Due to the usage of both millimeter-wave ranging radar and laser ranging radar to perform radar ranging, the two kinds of radars can adapt different circumstances so as to achieve the complementation effect, and thus enable the stable working for radar ranging in different circumstances and reduce the probability of making mistakes.

Furthermore, the device for braking a vehicle in the present embodiment further includes an alarm 15 configured to be electrically connected with the processor 12.

The alarm 15 is configured to make alarm with sound and light.

The processor 12 is further configured to actuate the alarm 15 to make alarm with sound and light when the indicating signal is received.

The processor 12 may actuate the alarm 15 to make alarm with sound and light at the same time of actuating the braking device 14 to start, which may implement indication to the driver and the passengers in the vehicle so that the driver and the passengers in the vehicle may be aware of safety.

In the present embodiment, after the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to performing braking, the misjudgment possibility for performing braking may be reduced, and thus the technical problem of being dangerous when implementing emergency braking using V2X in the related art is solved. Meanwhile, due to the usage of both millimeter-wave ranging radar and laser ranging radar to perform radar ranging, the two kinds of radars can adapt different circumstances so as to achieve the complementation effect, and thus enable the stable working for radar ranging in different circumstances and reduce the probability of making mistakes.

### Third Embodiment

The third embodiment of the present disclosure further provides a vehicle including the device for braking a vehicle provided by the foregoing embodiments.

The vehicle in the present embodiment can receive braking instructions transmitted by the front vehicle based on V2X due to the installation of the device of the foregoing embodiments; and detect the presence or non-presence of obstacles within the preset safety range by ranging radar. If the presence of obstacles within the preset safety range is detected, the braking device may be actuated to perform braking.

More particularly, as a possible implementation, when the vehicle receives a braking instruction, the vehicle may detect the presence or non-presence of obstacles within the preset safety range using ranging radar. If the presence of obstacles within the preset safety range is detected, the braking may be performed.

Alternatively, as another possible implementation, the vehicle may be in a working state of detecting obstacles in real-time. If the vehicle has detected obstacles within the preset safety range using the ranging radar in a preset time period before or after the braking instructions is received, the braking may be performed.

In the present embodiment, after the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to performing braking, the misjudgment possibility for performing braking may be reduced, and thus the technical problem of being dangerous when implementing emergency braking using V2X in the related art is solved.

### Fourth Embodiment

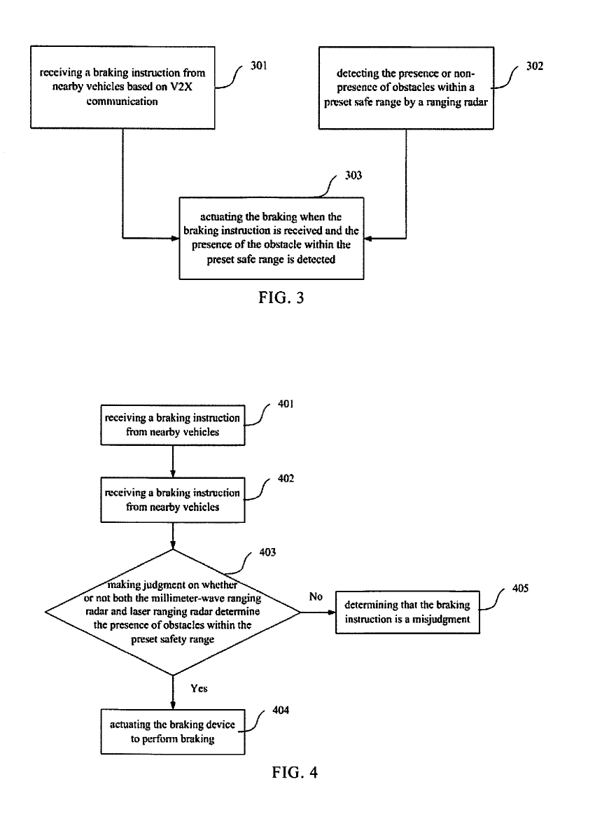

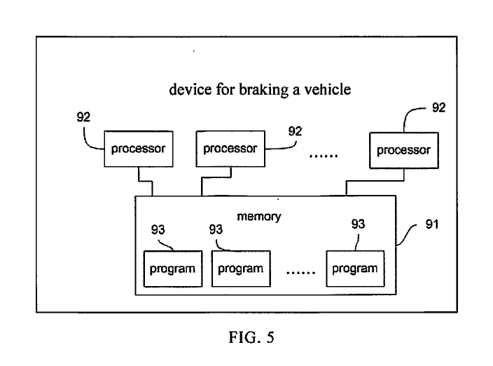

FIG. 3 is a flowchart of a method for braking a vehicle provided by embodiments of the present disclosure. As shown in FIG. 3, the method for braking a vehicle includes:

301: receiving a braking instruction from nearby vehicles based on V2X communication.

More particularly, during the traveling of a vehicle, if the front vehicle is performing braking, the front vehicle may transmit a braking instruction to the present vehicle based on V2X communication to instruct the present vehicle to perform corresponding braking measures, and thus rear-end collision may be prevented.

302: detecting the presence or non-presence of obstacles within a preset safe range by a ranging radar.

Furthermore, the ranging radar includes a millimeter-wave ranging radar and a laser ranging radar.

More particularly, it can be determined that there is an obstacle within a preset safety range when both the millimeter-wave ranging radar and laser ranging radar determine the presence of the obstacle within the preset safety range.

More particularly, the millimeter-wave ranging radar transmits a micro-wave signal of 77 GHz, and calculates the distance to the obstacle in front of the vehicle based on the arriving time of the reflected-wave. In normal case, the penetration capability of micro-wave is strongest and is able to adapt ranging work under different whether circumstances, but the micro-wave ranging is vulnerable to the reflecting-interference caused by the vehicles in adjacent lanes, which leads to the mistakes in determining distances. Laser ranging radar is configured to determine distances based on the reflecting time of the transmitted laser. Laser is widely used in automatic driving technology due to high accuracy, but is invulnerable to interference. However, the accuracy of laser would be attenuated in frog, which degrades its measuring accuracy. Due to the usage of both millimeter-wave ranging radar and laser ranging radar to perform radar ranging, the two kinds of radars can adapt different circumstances so as to achieve the complementation effect, and thus enable the stable working for radar ranging in different circumstances and reduce the probability of making mistakes.

303: actuating the braking when the braking instruction is received and the presence of the obstacle within the preset safe range is detected.

More particularly, as a possible implementation, when the vehicle receives a braking instruction, the vehicle may detect the presence or non-presence of obstacles within the preset safety range using the ranging radar. If the presence of obstacles within the preset safety range is detected, the braking may be performed.

Alternatively, as another possible implementation, the vehicle may be in a working state of detecting obstacles in real-time. If the vehicle has detected obstacles within the preset safety range using the ranging radar in a preset time period before or after the braking instructions is received, the braking may be performed.

To clarify the present embodiment, the present embodiment further provides a feasible flow for a method for braking a vehicle. FIG. 4 is a flowchart of a method for braking a vehicle. As shown in FIG. 4, the flow for vehicle braking includes:

401: receiving a braking instruction from nearby vehicles.

More particularly, the braking instruction may be received based on V2X communication.

402: actuating the millimeter-wave ranging radar and laser ranging radar to detect the presence or non-presence of obstacles within a preset safety range.

More particularly, after the braking instruction is received, the millimeter-wave ranging radar and laser ranging radar may be actuated to start at the same time so that the two radars may both detect the presence or non-presence of obstacles within the preset safety range.

It should be noted that, the term of “at the same time” as mentioned above should not be understood as same time in absolute time, but may mean the detection on the presence or non-presence of obstacles within the preset safety range may be performed with steps in parallel.

403: making judgment on whether or not both the millimeter-wave ranging radar and laser ranging radar determine the presence of obstacles within the preset safety range. If so, it is determined that there is an obstacle within the preset safety range, and go to the step of 404, otherwise to the step of 405.

More particularly, it can be determined that there is an obstacle within a preset safety range when both the millimeter-wave ranging radar and laser ranging radar determine the presence of the obstacle within the preset safety range. Both millimeter-wave ranging radar and laser ranging radar are used to perform radar ranging, the two kinds of radars can adapt different circumstances so as to achieve the complementation effect, and thus enable the stable working for radar ranging in different circumstances and reduce the probability of making mistakes.

404: actuating the braking device to perform braking.

405: determining that the braking instruction is a misjudgment.

More particularly, when both millimeter-wave ranging radar and laser ranging radar determine the non-presence of obstacles within the preset safety range, it can be determined that the braking instruction is a misjudgment and no braking can be performed.

In the present embodiment, after the device for braking a vehicle receives a braking instruction based on V2X, the device for braking a vehicle detects the presence or non-presence of obstacles within a preset safe range by a ranging radar, and if an obstacle is detected within the preset safe range, the braking device is actuated to perform braking. Because the presence or non-presence of obstacles within the preset safe range is detected by the ranging radar mounted on the vehicle prior to performing braking, the misjudgment possibility for performing braking may be reduced, and thus the technical problem of being dangerous when implementing emergency braking using V2X in the related art is solved. Meanwhile, due to the usage of both millimeter-wave ranging radar and laser ranging radar to perform radar ranging, the two kinds of radars can adapt different circumstances so as to achieve the complementation effect, and thus enable the stable working for radar ranging in different circumstances and reduce the probability of making mistakes.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

1. An apparatus for braking a vehicle, comprising a communication module, a processor, a ranging radar, and a braking device,
wherein the communication module, the ranging radar, and the braking device are electrically connected with the processor respectively,
the communication module is configured to receive a braking instruction from an adjacent vehicle based on V2X communication;
the ranging radar is configured to detect presence or non-presence of an obstacle within a preset safe range, and if the presence of an obstacle within the preset safe range is detected, transmit an indicating signal to the processor;
the processor is configured to transmit an activation signal to the braking device to actuate the braking device to perform braking when the braking instruction is received via the communication module and the indicating signal transmitted from the ranging radar is received; and
the braking device is configured to perform braking when the activation signal is received,
wherein the ranging radar comprises a millimeter-wave ranging radar and a laser ranging radar.

2. (canceled)

3. The apparatus for braking a vehicle according to claim 1, wherein when the ranging radar comprises a millimeter-wave ranging radar and a laser ranging radar, the ranging module is further configured to comprise a judging circuit electrically connected with the millimeter-wave ranging radar and the laser ranging radar respectively; and
the judging circuit is configured to judge whether or not both the millimeter-wave ranging radar and the laser ranging radar determine that there is an obstacle within the preset safe range, and transmit the indicating signal to the processor when both the millimeter-wave ranging radar and the laser ranging radar determine that there is an obstacle within the preset safe range.

4. The apparatus for braking a vehicle according to claim 1, wherein the processor is further configured to indicate the presence or non-presence of the obstacle within the preset safe range detected by the ranging radar when the braking instruction via the communication module is received, and to transmit an activation signal to the braking device to actuate the braking device to perform braking if the indicating signal transmitted from the ranging radar is received.

5. The apparatus for braking a vehicle according to claim 1, wherein the ranging radar is further configured to detect the presence or non-presence of the obstacle within the preset safe range in real-time, and to transmit an indicating signal to the processor when the presence of the obstacle within the preset safe range is detected,
the processor is further configured to transmit an activation signal to the braking device to actuate the braking device to perform braking, when the braking instruction is received via the communication module in a preset time period before or after the indicating signal transmitted from the ranging radar is received; and
the processor is further configured to transmit an activation signal to the braking device to actuate the braking device to perform braking, when the indicating signal transmitted from the ranging radar is received in the preset time period before or after the braking instruction is received via the communication module.

6. The apparatus for braking a vehicle according to claim 1, wherein the processor is connected with the braking device via a CAN (Controller Area Network) bus controller and a CAN bus.

7. The apparatus for braking a vehicle according to claim 1, further comprising an alarm electrically connected with the processor;
wherein the processor is further configured to actuate the alarm to cause sound and light when the indicating signal is received.

8. (canceled)

9. The apparatus for braking a vehicle according to claim 3, further comprising an alarm electrically connected with the processor;
wherein the processor is further configured to actuate the alarm to cause sound and light when the indicating signal is received.

10. The apparatus for braking a vehicle according to claim 4, further comprising an alarm electrically connected with the processor;
wherein the processor is further configured to actuate the alarm to cause sound and light when the indicating signal is received.

11. The apparatus for braking a vehicle according to claim 5, further comprising an alarm electrically connected with the processor;
wherein the processor is further configured to actuate the alarm to cause sound and light when the indicating signal is received.

12. A vehicle, comprising the vehicle braking apparatus according to of claim I.

13. A method for braking a vehicle, comprising:
receiving a braking instruction from nearby vehicles based on V2X communication;
detecting the presence or non-presence of obstacles within a preset safe range by a ranging radar; and
actuating a braking device to perform braking when the presence of the obstacle within the preset safe range is detected,
wherein the ranging radar comprises a millimeter-wave ranging radar and a laser ranging radar.

14. The method for braking a vehicle according to claim 13, wherein the detecting the presence or non-presence of obstacles within a preset safe range by the ranging radar comprises:
determining that there is an obstacle within the preset safety range when both the millimeter-wave ranging radar and laser ranging radar determine the presence of obstacles within the preset safety range.

15. An apparatus for braking a vehicle, comprising: one or more processors;
a memory; and
one or more programs stored in the memory and configured to perform operations when executed by the one or more processors, wherein the operations comprises:
receiving a braking instruction from nearby vehicles based on V2X communication;
detecting the presence or non-presence of obstacles within a preset safe range by a ranging radar; and
actuating a braking device to perform braking when the presence of the obstacle within the preset safe range is detected,
wherein the ranging radar comprises a millimeter-wave ranging radar and a laser ranging radar.

16. The apparatus for braking a vehicle according to claim 15, the detecting the presence or non-presence of obstacles within a preset safe range by the ranging radar comprises:
determining that there is an obstacle within the preset safety range when both the millimeter-wave ranging radar and laser ranging radar determine the presence of obstacles within the preset safety range.
